(19) United States
(12) Patent Application Publication
(10) Pub. No.: US 2004/0132209 A1
(43) Pub. Date: Jul. 8, 2004

(54) Multi-chamber treatment apparatus and method

(76) Inventors: Ara J. Alexanian, Des Plaines, IL (US); Kerry S. Crosby, Mount Prospect, IL (US); David M. Johnson, Des Plaines, IL (US); David S. Bem, Seabrook, TX (US); Duncan E. Akporiaye, Oslo (NO); Arne Karlsson, Oslo (NO); Ivar M. Dahl, Oslo (NO)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/337,040

(22) Filed: Jan. 3, 2003

(51) Int. Cl. B01L 3/00

(52) U.S. Cl. 436/180; 422/100

(57) ABSTRACT

A material treatment assembly comprises a first manifold having an inlet channel a second manifold having an outlet channel, a plurality of chambers in fluid communication with the first and second manifolds so that a fluid flows from the inlet channel through a material in each chamber and into the outlet channel, wherein the material maintains a position with respect to the manifolds, and at least one seal for each of the chambers adapted to permit repeated placement of material. A method for treating material comprises the steps of providing a plurality of chambers, loading material into the chambers, providing an inlet manifold having an inlet channel and an outlet manifold having an effluent channel, sealing the chambers into fluid communication with the manifolds and flowing a fluid from the inlet manifold, though the material and into the effluent manifold.

### MULTI-CHAMBER TREATMENT APPARATUS AND METHOD STATEMENT REGARDING FEDERALLY SPONSORED RESEARCH OR DEVELOPMENT

This invention was made under the support of the United States Government, Department of Commerce, National Institute of Standards and Technology (NIST), Advanced Technology Program, Cooperative Agreement Number 70NANB9H3035. The United States Government has certain rights in the invention.

### BACKGROUND OF THE INVENTION

1. Field of the Invention

The present invention is related to a multi-chamber treatment method and apparatus, particularly for the simultaneous treatment of a plurality of materials, such as catalysts.

2. Description of the Related Art

Before a material is selected for use in a commercial application, for example catalysts for hydrocarbon reactions in petroleum refining, a great number of materials may be examined for use in the envisioned application. A large number of material compositions may be synthesized, processed and screened while under consideration as candidates.

The traditional approach to the treatment of new materials has been a sequential one. For example, one new potential material undergoes a treatment step in a vessel. Upon completion of the treatment, the one material is removed from the vessel and a second material is loaded. The treatment is repeated on the freshly loaded material. The process is repeated sequentially for each of the materials. This approach is drawn out and labor intensive, introducing many chances for experimental error. Overall, processing of a plurality of new material formulations is a lengthy process at best.

One method that attempts to speed up the processing of a plurality of materials is to place a small amount of each material into one of several small containers and then process each container separately. An example of a container and processing apparatus is disclosed in the commonly assigned patent application having Atty. Docket # 103328, filed contemporaneously herewith, the disclosure of which is incorporated herein by reference.

Combinatorial chemistry has dealt mainly with the synthesis of new compounds. For example, U.S. Pat. No. 5,612,002 B1 and U.S. Pat. No. 5,766,556 B1 teach an apparatus and a method for simultaneous synthesis of multiple compounds. Akporiaye, D. E.; Dahl, I. M.; Karlsson, A.; Wendelbo, R. Angew Chem. Int. Ed. 1998, 37, 9-611 disclose a combinatorial approach to the hydrothermal synthesis of zeolites, see also WO 98/36826. Combinatorial approaches have also recently been used for the evaluation and screening of catalysts; see for example commonly assigned U.S. Pat. Nos. 6,342,185 and 6,368,865 and U.S. patent applications Ser. Nos. 10/095,395, 10/095,879 and 10/095,934.

Many of the same concerns apply to the design of a combinatorial treatment array as to the combinatorial screening and evaluation arrays described in the above patents or applications. For example, it is important that each reactor be sealed from its surroundings so that a known amount of gas flows through each material being treated. It is also important to ensure that the gas flowing to each well of the assembly is controllable so that various flows of the treatment fluid can be fed to each chamber. Also, it is important for the temperature in each well to be strictly controlled to ensure each catalyst is heated properly.

What is needed is a multi-well reactor assembly for the simultaneous treatment of a plurality of materials that addresses the above concerns.

### BRIEF SUMMARY OF THE INVENTION

In accordance with the present invention, a novel and improved material treatment assembly is provided. The inventive assembly includes a first manifold having an inlet channel, a second manifold having an outlet channel, a plurality of chambers arranged for fluid communication with the first and second manifolds so that fluid can flow from the inlet channel through material in each of the plurality of chambers and thence into the outlet channel, wherein the material in each of the plurality of chambers maintains a position for treatment with respect to at least one of the manifolds, and at least one seal for each of the plurality of chambers, wherein the seal is adapted to permit repeated placement and removal of material.

Also in accordance with the present invention, a method for treating materials in a multi-chamber assembly is provided. The inventive method includes the steps of providing a plurality of chambers, loading material to be treated into each of the plurality of chambers, providing an inlet manifold having at least one inlet channel and an effluent manifold having at least one effluent channel, sealing the chambers into fluid communication with said manifolds, and flowing a fluid from the inlet manifold, through the material in each of the chambers, and into the effluent manifold.

The improved material treatment assembly and method allow a plurality of materials to be treated simultaneously under the same or different treatment conditions, greatly reducing the time required to treat several materials.

These and other objects, features and advantages are evident from the following description of an embodiment of the present invention, with reference to the accompanying drawings.

### BRIEF DESCRIPTION OF THE SEVERAL VIEWS OF THE DRAWINGS

FIG. 1 is a side sectional view of a multi-chamber treatment assembly, shown with four chambers enclosed by four tubes.

FIG. 2 is an elevation view of an inlet manifold of the multi-chamber treatment assembly.

FIG. 3 is an elevation view of an effluent manifold of the multi-chamber treatment assembly.

FIG. 4 is a side sectional view of a first embodiment of a reactor well for enclosing the chamber, shown engaged with the inlet manifold and the effluent manifold.

FIG. 5 is a side sectional view of a second embodiment of a reactor well for enclosing the chamber.

FIG. 6 is a side sectional view of a third embodiment of a reactor well for enclosing the chamber.

FIG. 7 is side sectional view of a fourth embodiment of a reactor well for enclosing the chamber, shown engaged with the inlet manifold and the effluent manifold.

FIG. 8 is a side sectional view of a multi-chamber treatment assembly, shown with an alternative sealing apparatus.

### DETAILED DESCRIPTION OF THE INVENTION

An improved multi-chamber treatment assembly 10 for the simultaneous treatment of a plurality of materials 2 is shown in the figures. The treatment assembly 10 includes a plurality of chambers 12 for holding materials 2 that are to be heat treated, wherein the chambers 12 are enclosed within tubes 14 or reactor wells 16. The arrangement of tubes 14 or reactor wells 16 in treatment assembly 10 allows for the simultaneous and parallel treatment of the plurality of materials 2.

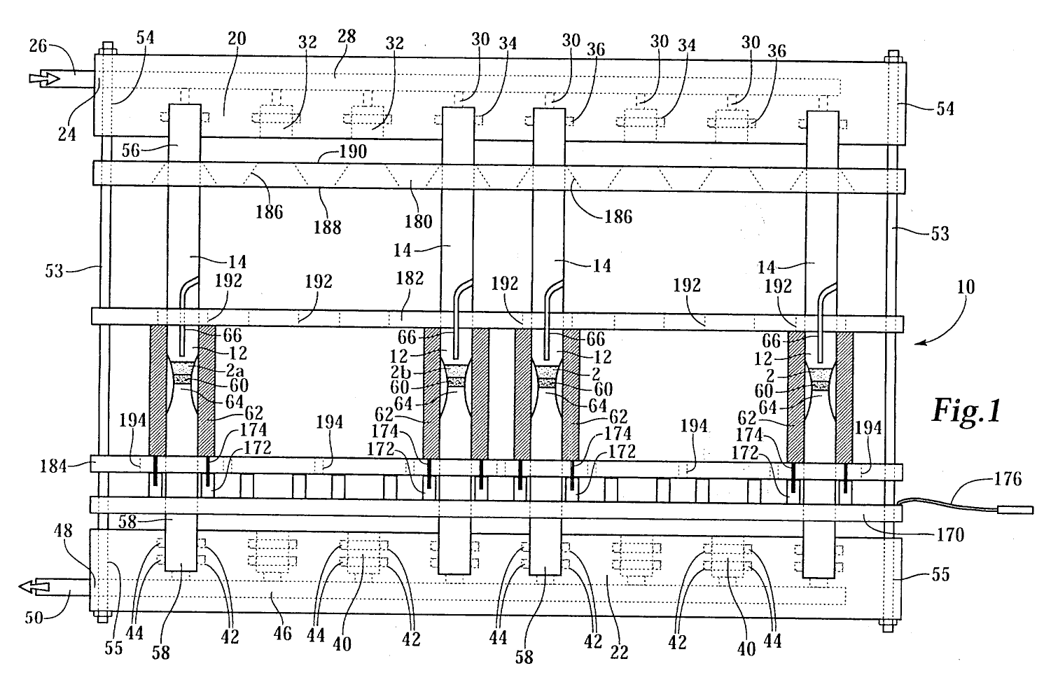

Turning to FIG. 1, the inventive material treatment assembly includes an inlet manifold 20 having at least one inlet channel 28, an effluent manifold 22 having at least one effluent channel 46, a plurality of chambers 12 arranged for fluid communication with inlet manifold 20 and effluent manifold 22 so that a fluid can flow from inlet channel 28, through a material 2 in each of the plurality of chambers 12 into effluent channel 46. Material 2 maintains a position with respect to at least one of the manifolds and treatment assembly 10 includes at least one seal, such as o-rings 36 and 44, described below, for each of the chambers 12, wherein the seal is adapted to permit repeated placement and removal of material 12 into position and out of position with respect to at least one of the manifolds.

Each chamber 12 of multi-chamber treatment assembly 10 encloses a material 2 at a position for treatment at a desired location relative to inlet manifold 20 and effluent manifold 22. Each chamber 12 includes an internal volume sufficient to enclose a predetermined amount of material 2. In one embodiment, each chamber 12 has a volume of between about 0.1 cm³ and about 50 cm³, and preferably about 3 to 15 cm³. Chamber 12 is preferably designed to hold between about 0.1 grams and about 10 grams, and preferably about 5 grams of material 2 [Inventors, please confirm volume of chamber and typical mass of catalyst in chamber].

Materials 2 in chambers 12 may be treated with heat and with a treatment fluid flowing through chambers 12. Each chamber 12 is sealed from its surroundings to ensure parallel flow of the treatment fluid through the material 2 in each chamber 12. In most applications, the treatment fluid is in the gaseous state and flows through each chamber 12 to perform the desired treatment to material 2. Also, a treatment gas more easily flows uniformly through chamber 12 to ensure homogenous treatment of material 2. If a component that is liquid at room temperatures, such as H₂ O, is desired to be used as a treatment fluid, it is usually vaporized into gaseous form before flowing into chambers 12.

Treatment assembly 10 can be operated with fluid flow rates through each chamber 12 of between about 0.1 cm³/min to about 1000 cm³/min, preferably between about 0.5 cm³/min and about 25 cm³/min. Materials 2 can also be heated, as described below, to temperatures between room temperature (about 20° C.), to high temperatures of about 1000° C., and preferably between about 300° C. and about 800° C. Other process conditions that can be altered in treatment apparatus 10 include materials 2 being processed, and treatment fluids used to treat materials 2.

Preferred materials 2 that can be treated within multi-chamber treatment assembly 10 include inorganic catalysts, such as metallic catalysts used in the petrochemical industry, metals, and other inorganic materials, such as adsorbents, which can undergo heat treatment before the material has certain desired properties.

Preferably, a material 2 to be treated in heat treatment assembly 10 is in particulate form, such as a fine powder having a small particle size, so that treatment of material 2 can be essentially uniform throughout an entire sample of material 2. Examples of materials include inorganic catalysts typically used in the petrochemical industry.

Examples of catalysts that may be processed using the present invention include those effective in a wide variety of hydrocarbon conversion processes such as cracking, hydrocracking, alkylation of both aromatics and isoparaffins, isomerization, polymerization, reforming, dewaxing, hydrogenation, dehydrogenation, transalkylation, dealkylation, hydration, dehydration, hydrotreating, hydrodenitrogenation, hydrodesulfurization, methanation, ring opening, and syngas shift processes. Specific examples are discussed in H. Pines, The Chemistry Of Catalytic Hydrocarbon Conversions, Academic Press (1981).

Treatment assembly 10 can be used to simultaneously treat a plurality of materials 2 in parallel using various mixtures of fluids. In a preferred embodiment of the present invention, treatment assembly 10 has the possibility of mixing several separate fluids. Heat treatment assembly 10 can perform various types of treatment, some examples being a reduction treatment using hydrogen gas (H₂), an oxidation treatment with a mixture of nitrogen gas (N₂) and air, or a steaming treatment with a mixture of nitrogen gas, air and water vapor (H₂O). Examples of fluids being fed to treatment assembly 10 are pure components, such as pure hydrogen gas or oxygen gas, or mixtures of fluids, such as half nitrogen gas and half air. Process liquids used in treatment assembly 10 can be pure liquids, such as pure water, or mixtures, such as hydrochloric acid and water (aqueous HCl).

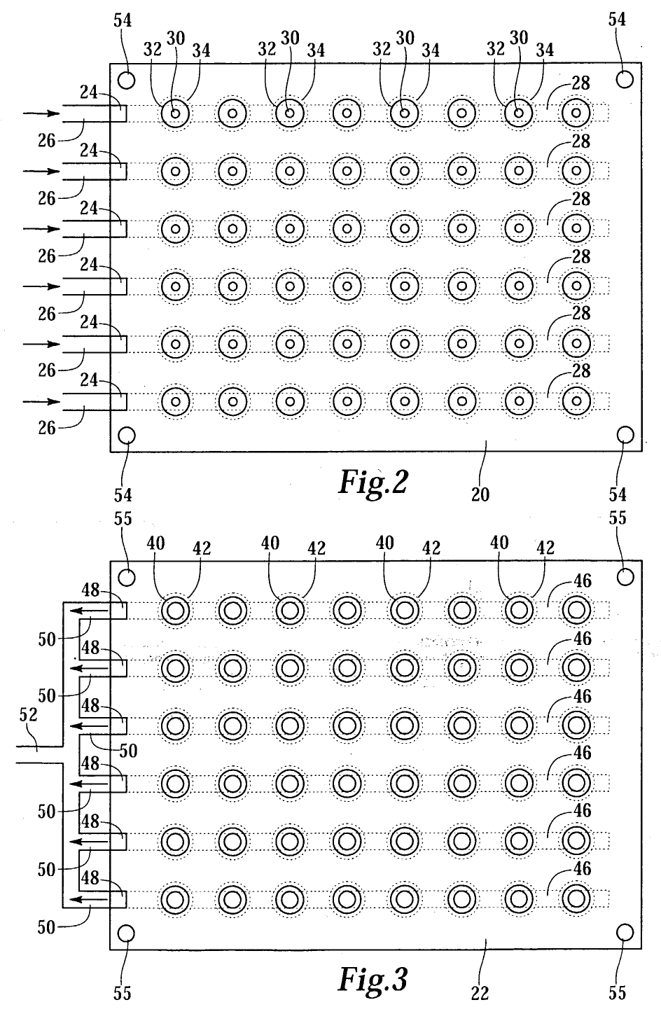

A preferred embodiment of inlet manifold 20 is shown in FIGS. 1 and 2. Inlet manifold 20 holds and seals the plurality of chamber 12 in treatment assembly 10. Inlet manifold 20 includes a plurality of inlet line connections 24, each being fed by one of a plurality of inlet lines 26. Each inlet line connection 24 feeds one of a plurality of inlet channels 28, as is best shown in FIG. 2. Each inlet channel 28 feeds a plurality of restriction orifices 30, wherein each restriction orifice 30 feeds an inlet recess 32, and each inlet recess 32 receives an inlet end of a tube 14 or reactor well 16, as described below.

Restriction orifices 30 help control the flow rate of the treatment fluid through chambers 12. The small diameter of each restriction orifice 30 relative to the diameter of inlet channel 28 and inlet recess 32 regulates the flow at a predetermined rate through chambers 12. Restriction orifices 30 can also help control the flow rate of the treatment fluid when located downstream of chamber 12 in effluent manifold 22 and would still provide flow control of the treatment fluid.

To avoid corrosion, the tubes or reactor wells that enclose chambers 12, described below, are often constructed out of materials such as quartz or glass. Therefore, low pressure is desirable within chamber 12 to protect the fragile and expensive quartz or glass from costly damage. A fluid flowing through a small orifice, such as restriction orifice 30, undergoes a large pressure drop compared to the pressure drop within a channel. In one embodiment, restriction orifice 30 has a diameter of about 0.025 inches, and the treatment fluid undergoes between about 50% and about 90% of its pressure drop at or before restriction orifice 30, and preferably between about 65% and about 85% of its pressure drop at or before restriction orifice 30. The desired low pressure in chamber 12 is preferably maintained by locating restriction orifices 30 upstream of chamber 12 in inlet manifold 20, as shown in FIG. 1.

In a preferred embodiment, shown in FIG. 2, inlet manifold 20 includes six inlet line connections 24, each feeding one of six inlet channels 28. Each inlet channel 28 feeds eight restriction orifices 30, which in turn feed into one of eight inlet recesses 32 so that there are a total of forty-eight inlet recesses 32 capable of feeding a total of forty-eight chambers 12.

In one embodiment, each inlet recess 32 includes an o-ring groove 34 for retaining an o-ring seal 36, see FIG. 1. Each o-ring seal 36 in each inlet recess 32 provides a means for sealing each chamber 12 into fluid communication with inlet recess 32. Each inlet recess 32 generally has the same cross-sectional shape as a corresponding chamber 12 to permit formation of a seal for flowing the treatment fluid from inlet recess 32 into chamber 12 without leakage.

Turning to FIGS. 1 and 3, a preferred embodiment of effluent manifold 22 is shown. Similar to inlet manifold 20, effluent manifold 22 holds and seals the plurality of chamber 12 in position. Effluent manifold 22 includes a plurality of effluent recesses 40, each effluent recess 40 receiving an outlet end of chamber 12, as shown in FIG. 1. In one embodiment, each effluent recess 40 includes at least one o-ring groove 42 retaining an o-ring 44 and in a preferred embodiment, shown in FIG. 1, each effluent recess 40 includes two o-ring grooves 42 holding two o-rings 44, one in each o-ring groove 42. Two o-rings 44 are preferred so that upon separation of inlet manifold 20 and effluent manifold 22, tubes remain within effluent recesses 40 rather than randomly staying within inlet manifold 20 and effluent manifold 22.

Each effluent recess 40 should have a cross sectional shape that is generally the same as the cross section of a corresponding chamber 12 so that a seal can be formed so that chamber 12 is in fluid communication with effluent recess 40 without leakage.

Each effluent recess 40 feeds into one of a plurality of effluent channels 46, shown in FIG. 3. Each effluent channel 46 of effluent manifold 22 is fed by a plurality of effluent recess 40 so that a plurality of chamber 12 feed each effluent channel 46.

Continuing with FIG. 3, each effluent channel 46 feeds one of a plurality of outlet line connections 48, which in turn feed one of a plurality of outlet lines 50. Because multi-chamber treatment assembly 10 is to be used for treatment of materials 2, and not for analysis, such as for screening of potential catalysts, it is unnecessary to analyze the effluent fluid to determine its composition after treatment. Therefore, the outlet lines 50 are combined into a common effluent line 52 for disposal of the effluent fluid.

In a preferred embodiment, a total of forty-eight effluent recess 40 are included in effluent manifold 22 allowing for a total of forty-eight chamber 12 to be used with treatment assembly 10. Each of the forty-eight effluent recess 40 feed into one of six effluent channels 46, so that there are eight effluent recess 40 for each effluent channel 46, with each effluent channel 46 feeding into one of six outlet lines 50.

Treatment assembly 10 includes a set of bolts 53 which pass through a set of holes 54 in inlet manifold 20 and a set of holes 55 in effluent manifold 22. Bolts 53 hold inlet manifold 20 and effluent manifold 22 in position with respect to each other and with respect to chamber 12 so that materials 2 are in a predetermined position relative to the manifolds. Bolts 53 also help to keep inlet manifold 20 and effluent manifold 22 parallel to each other, and keep tubes 14 or reactor wells 16 tightly sealed within the manifolds.

Inlet manifold 20 and effluent manifold 22 are made from materials that are resistant to corrosion from the treatment fluid and that can withstand the highest expected temperature that feed manifold and effluent manifold 22 will encounter. In one embodiment, where the treatment fluid is corrosive, e.g. wet chlorine gas, inlet manifold 20 and effluent manifold 22 are made from glass filled TEFLON™.

In a preferred embodiment, shown in FIG. 1, inlet manifold 20 is located generally above chamber 12 and effluent manifold 22 is located generally below chamber 12 so that the treatment fluid flows from inlet manifold 20 generally downward through chamber 12 and into effluent manifold 22. The description of treatment assembly 10 in this arrangement does not preclude other orientations, such as reversal of the inlet and effluent manifolds so that the treatment fluid flows generally upward though chambers 12.

Returning to FIG. 1, in one embodiment of the present invention a plurality of tubes 14 are provided to enclose chamber 12 and materials 2. Each tube 14 is preferably generally cylindrical in shape and is open at both an inlet end 56 and an effluent end 58 so that a material 2 can be easily loaded into tube 14 and unloaded out of tube 14. In one embodiment, tube 14 is about 25 cm long and has a diameter of about 1.0 cm. Tube 14 is made from a material sufficient to resist corrosion caused by the treatment fluid flowing through tube 14. For example, if the treatment fluid included wet chlorine gas, tube 14 can be constructed from corrosive resistant quartz or other materials such as stainless steel, Hastelloy, Incoloy, and Inconnel.

Inlet end 56 is inserted into inlet recess 32 and effluent end 58 is inserted into an effluent recess 40 so that inlet o-ring 36 engages and seals with inlet end 56 and effluent o-rings 44 engage and seal with effluent end 58. O-ring seals 36, 44 ensure that chamber 12 in each tube 14 is isolated from its surroundings and from the other chambers allowing a known amount of treatment fluid to flow through a material 2 in each chamber 12.

Continuing with FIG. 1, each tube also includes a material support 60 connected to an inner surface of tube 14 that is generally centered along the length of tube 14. Material support 60 is constructed so that it is sufficiently strong to support material 2 while still allowing the treatment fluids flowing through chamber 12 to pass through tube 14. In one embodiment, the diameter or tube 14 is smaller where material support 60 is connected to tube 14 so that a smaller material support 60 is needed and so that material 2 may be conserved.

Material support 60 is preferably made out of a material that is resistant to corrosion from the treatment fluid flowing through tube 14, such as a sintered glass or quartz, but could be any material that is permeable to the fluids flowing through tube 14, examples being a sintered metal, such as Hastelloy. Other possible materials of material support 60 include Raney metals, electro-bonded membranes, etched alloy membranes, and fine meshed screens with gaps smaller than the minimum material size, but large enough to allow the gas feed and vapor to flow adequately.

A heating element 62 can be included for heating material 2 within chamber 12. Heating element 62 localizes heating energy to create a heating zone 64 inside tube 14 so that all of material 2 is within heating zone 64. In a preferred embodiment, heating element 62 is generally cylindrical in shape and has an inner diameter that is greater than the outer diameter of tube 14 so that heating element 62 completely encircles tube 14. The length of heating element 62 is typically significantly shorter than the length of tube 14 but generally long enough to enclose all of material 2 within heating zone 64, as shown in FIG. 1.

Continuing with FIG. 1, each tube 14 can also include a thermal well 66 extending into chamber 12 of tube 14. FIG. 1 depicts thermal well 66 as an integral conduit formed from the base material of tube 14 for receiving a thermocouple (not shown) in order to measure the temperature within chamber 12. Preferably, thermal well 66 completely separates the thermocouple from chamber 12 so that no treatment fluid can leak out of tube 14 and so that no corrosive treatment fluid can come into contact with the thermocouple.

Treatment assembly 10 also includes a circuit board 170 for providing a conduit to deliver power to each heating element 62 for each of the plurality of chambers 12. Circuit board 170 is electronically connected to a heating element 62 and a thermocouple for each of the plurality of chambers 12.

In one embodiment, each heating element 62 is removably connected to circuit board 170 via two element connections 172. Each heating element 62 includes two leads 174 which are inserted into element connections 172, as shown in FIG. 1, to complete a circuit through heating element 62. Leads 174 are evenly spaced about 180° from each other, so that leads 174 are on generally opposite sides of heating element 62. Similarly, element connections 172 are also evenly spaced about 180° apart and are placed on circuit board 170 so that they are aligned with leads 174. The generally even spacing of element connections 172, and leads 174 allows for generally even support of heating element 62 when it is plugged into circuit board 170, A removable heating element 62, such as the one shown in FIG. 1, is preferred because it allows for the replacement of a heating element 62 should it fail.

A preferred embodiment of heating element 62 having the desired thermal properties and the desired alignment of leads 174 is Drawing # QA-SB290-FB0526-A manufactured by Kyocera.

A plurality of lead wires 176 electronically connect circuit board 170 to a controlling computer (not shown) which controls heating elements 62. The controlling computer calculates a difference between the temperature measured by the thermocouple and a desired temperature. The controlling computer than directs, via a multi-loop controller (not shown) and circuit board 170, how much energy should be input to each heating element 62, depending on whether the measured temperature is too high or too low.

For example, if there are a total of forty-eight chamber 12 in multi-chamber treatment assembly 10, a forty-eight loop controller would be used to control the forty-eight heating elements 62 independently heating each of the chambers 12.

The thermocouple can be designed to measure the temperature at a certain point within chamber 12, as shown in FIG. 1, which requires thermal well 66 to provide a path for the thermocouple into chamber 12 so that a probe (not shown) of the thermocouple will be within chamber 12. Alternatively, the thermocouple can be designed so that the probe is within heating element 62 to measure the temperature of heating element 62 itself, which requires no thermal well into chamber 12. The temperature within chamber 12 can then be estimated using known heat transfer calculations. The location of the probe is not important so long as the thermocouple and circuit board 170 can effectively control the temperature of material 2 using heating element 62.

The controlling computer can control the temperature of material 2 to a constant temperature so that once a desired temperature is reached the computer simply maintains this temperature throughout the remainder of the treatment of material 2. Alternatively, the controlling computer can control the temperature so that material 2 undergoes a predetermined temperature profile such as a gradual ramp-up in temperature, or several different temperature levels at specific times and for specific intervals during the treatment process.

After inlet end 56 of tube 14 has been sealed into inlet recess 32 and effluent end 58 has been sealed into effluent recess 40, a treatment fluid, or plurality of treatment fluids can be fed to treatment assembly 10 via inlet lines 26. Each tube 14 can hold a different material 2 and one or more treatment fluids or mixtures of treatment fluids can be fed to treatment assembly 10, and the treatment fluid feeds can be arranged to feed in a variety of configurations, as described below, so that treatment assembly 10 can perform several different treatments to several different materials.

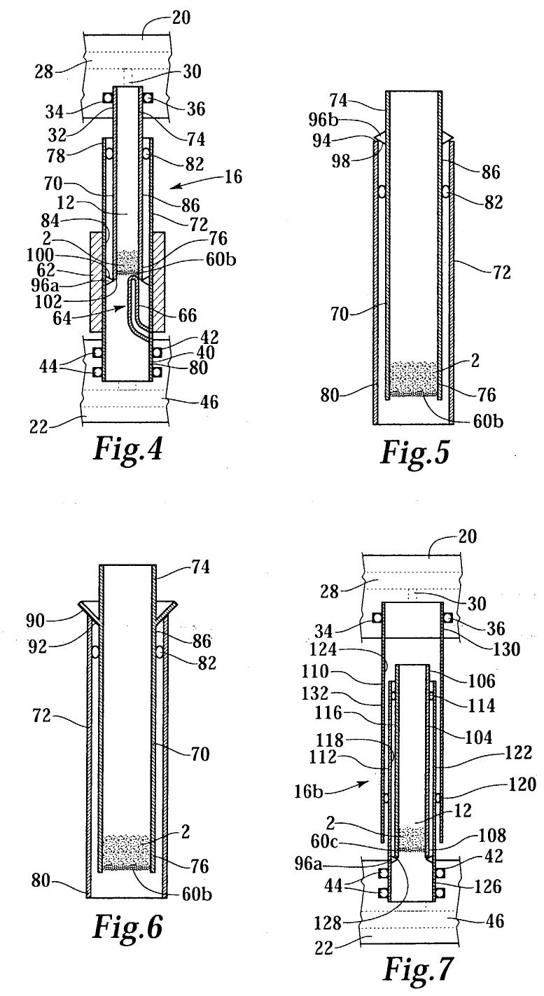

Turning to FIG. 4, another embodiment of the present invention is shown wherein each chamber 12 is enclosed within a reactor well 16. Each reactor well 16 includes a basket 70 which encloses chamber 12 and retains material 2, and a housing 72 surrounding basket 70.

As shown in FIG. 4, each basket 70 includes an inlet end 74 for receiving a treatment fluid and an outlet end 76 through which the treatment fluid exits basket 70. Each housing 72 includes an inlet end 78 for receiving a corresponding basket 70, and an outlet end 80 through which the treatment fluid exits reactor well 16. Each reactor well 16 also includes a basket seal 82 for sealing between basket 70 and housing 72.

The material of construction of basket 70 and housing 72 is a material sufficiently resistant to corrosion from the treatment fluid flowing through reactor well 16 and that can withstand the highest expected temperature within reactor well 16. Examples of materials of construction for basket 70 and housing 72 include stainless steel, Hastelloy, Incoloy, and Inconnel

A porous material support 60b is retained by basket 70 and comprises a suitable material that is permeable to the treatment fluid flowing through reactor well 16, preferably of the type described above.

In a preferred embodiment, basket 70 and housing 72 are generally cylindrical in shape. The diameter of basket 70 permits its insertion into housing 72 in a nested configuration with a predetermined tolerance between an inner surface 84 of housing 72 and an outer surface 86 of basket 70. Basket 70 does not extend to the bottom of housing 72, as shown in FIG. 4, to position material 2 within a heating zone 64 and a heating element 62, as described below. In one embodiment, basket 70 has a length of about 141 mm, an ID of 3 mm and an OD of 6 mm and the housing has length of about 242 mm, an ID of 8 mm and an OD of 11 mm.

A heating element 62 may also be placed around housing 72, as shown in FIG. 4, to heat material 2 within chamber 12. Energy from heating element 62 creates a localized heating zone 64. Inside housing 72. In a preferred embodiment, heating element 62 is also generally cylindrical in shape and has a diameter that is greater then the diameter of housing 72 so that heating element 62 completely encircles housing 72. The length of heating element 62 is significantly shorter than the length of either basket 70 or housing 72. Heating element 62 is axially positioned along housing 72 so that placing basket 70 within housing 72 puts all of material 2 within heating zone 64, as shown in FIG. 4.

In one embodiment, housing 72 also includes a thermal well 66b for receiving a thermocouple (not shown). The thermocouple measures the temperature of material 2 within heating zone 64. And compares the measured temperature with a desired, predetermined temperature. If there is a difference between the measured temperature and the predetermined temperature, heating element 62 is controlled to compensate for this difference. For example, if the temperature measured by the thermocouple is too high the difference between the actual temperature and the predetermined temperature is calculated. This difference is used to lower the input to heating element 62.

Each reactor well 16 may also include a positioner for positioning basket 70 within housing 72 so that material 2 is within heating zone 64. In one embodiment, shown in FIG. 4, the positioner is a set of projections 96a that radially extend inwardly from an inner surface 84 of housing 72 within heating zone 64. To create an effective diameter between projections 96a that is smaller than the diameter of basket 70. When basket 70 is placed into housing 72, a lower rim 102 at outlet end 76 of basket 70 contacts upper surfaces 100 of projections 96a, keeping basket 70 in the desired position.

FIG. 5 shows a second embodiment wherein the positioner is a set of projections 96b, also known as stops, which extend radially outward from an outer surface 86 of basket 70 near inlet end 74 to create an effective diameter of basket 70 that is greater than the diameter of housing 72. Projections 96b include bottom surfaces 98 so that when basket 70 is placed within housing 72, bottom surfaces 98 of projections 96b contact upper rim 94 of housing 72, and keep basket 70 in the desired position within housing 72.

In a third embodiment, shown in FIG. 6, the positioner is a flange 90 near inlet end 74 of basket 70. Flange 90 is generally annular in shape and extends radially outward to a diameter that is greater than the diameter of housing 72. When basket 70 is placed within housing 72, a bottom surface 92 of flange 90 contacts an upper rim of housing 72 and prevents basket 70 from being positioned any lower in housing 72.

Returning to FIG. 4, a predetermined amount of material 2 is retained within chamber 12 in basket 70. Outlet end 76 of basket 70 is inserted into inlet end 78 of housing 72 until the positioner (for example, projections 96b) position basket 70 in the desired location. Basket seal 82 is also engaged between basket 70 and housing 72 so that the treatment fluid will not leak out of chamber 12 from between basket 70 and housing 72. Outlet end 80 of housing 72 is inserted into effluent recess 40 of effluent manifold 22 so that effluent o-ring seals 44 are engaged between effluent recess 40 and housing 72 and inlet end 74 of basket 70 is inserted into inlet recess 32 of inlet manifold 20 so that inlet o-ring 36 is engaged between inlet recess 34 and basket 70.

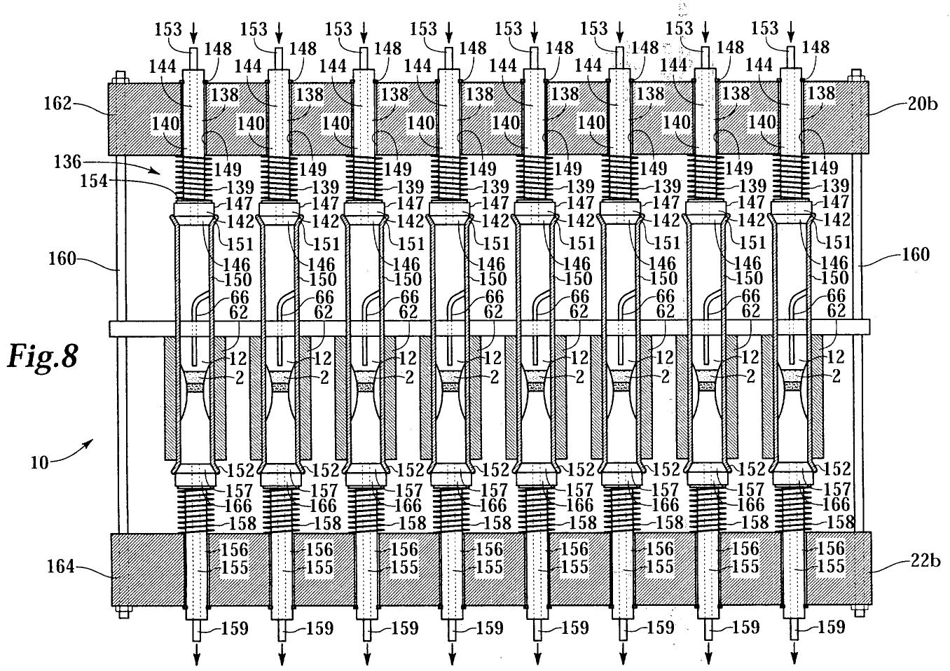

Turning to FIG. 7, yet another embodiment of the present invention is shown wherein each chamber 12 is provided within an alternative reactor well 16b having an insert 104 placed between an inlet housing 110 and an effluent housing 112. Insert 104 is similar to basket 70 of the above described embodiment in that it retains material 2 within chamber 12 and includes an inlet end 106 through which the treatment fluid flows and an outlet end 108 through which the treatment fluid exits. Insert 104 also includes a material support 60c for supporting material 2 within chamber 12 in insert 104, preferably of the type described above.

Continuing with FIG. 7, insert 104 is housed within inlet housing 110 and effluent housing 112. In one embodiment, insert 104 is spaced within effluent housing 112 and effluent housing 112 is spaced within inlet housing 110 in a nested configuration, as shown in FIG. 7. An insert seal 114 is engaged between an exterior surface 116 of insert 104 and an interior surface 118 of effluent housing 112 so that the treatment fluid does not leak past material 2 in insert 104 and a housing seal 120 is engaged between an exterior surface 122 of effluent housing 112 and an interior surface 124 of inlet housing 110 to ensure that the treatment fluid does not leak from the housings to their surroundings.

The present invention is not limited to a particular nesting arrangement. Alternatively (not shown), with proper sealing, the insert may nest within the inlet housing, which in turn may nest within the effluent housing.

As shown in FIG. 7, a positioner is also included, shown as projections 96a which abut rim 128 of insert 104, to position insert 104 within effluent housing 112 and inlet housing 110 in a manner similar to that described for reactor well 16 in FIG. 4.

Inlet housing 110 is sealed within inlet manifold 20 by o-ring 36 and effluent housing 112 is sealed within effluent manifold 22 by o-rings 44 so that the treatment fluid is fed to chamber 12 without leakage through the use of o-rings and recesses in a manner similar to that previously described.

In an alternative embodiment (not shown), inlet housing 110 is connected to inlet manifold 20 and effluent housing 112 is connected to effluent manifold 22 rather than sealing the housings into the manifolds. The housings can be permanently or removably fixed to the manifolds in any desired manner that provides suitable resistance to leakage, including welding, bonding or threading.

Material 2 is retained within chamber 12 in insert 104 and insert 104 is nested within effluent housing 112 and inlet housing 110 so that insert seal 114 is engaged between insert 104 and either inlet housing 110 or effluent housing, and so that housing seal 120 is engaged between inlet housing 110 and effluent housing 112. Inlet housing 110 is either sealed within inlet recess 32, such as with o-ring 36, or inlet housing 110 is connected to inlet manifold 20. Similarly, effluent housing 112 is either sealed within effluent recess 40, i.e. by o-rings 44, or effluent housing is connected to effluent manifold 22. In this configuration, the treatment fluid is fed into inlet housing 110, wherein insert seal 114 and housing seal 120 ensure that the treatment fluid flows into insert 104. The treatment fluid flows though material 2 in chamber 12 of insert 104 and flows out of insert 104 and into effluent housing 112 through outlet end 108. Finally, the treatment fluid flows out of effluent housing and into effluent manifold 22.

In an alternative embodiment of the present invention, shown in FIG. 8, a surface-to-surface sealing apparatus 136 is employed to seal each chamber 12 from its surroundings. Each surface-to-surface seal 136 is integrated with inlet manifold 20b and effluent manifold 22b, and includes inserts 138 and 156 and springs 139 and 158.

Each insert 138 includes a generally cylindrical main section 140 and a sealing head 142 having a cylindrical outer surface 147 defining a diameter that is slightly larger than the diameter of main section 140. Insert 138 defines an internal conduit 144 running throughout the length of insert 138, wherein the treatment fluid flows from a feed line 153 into conduit 144. Sealing head 142 ends in a truncated cone 146 which angles inwardly from outer surface 147 toward conduit 144. Insert 138 extends through a cylindrical bore 149 defined by the thickness of inlet manifold 20b for translational movement of insert 138 therein. Main section 140 of insert 138 extends above inlet manifold 20b and is engaged by a snap ring 148 which prevents withdrawal of insert 138 from the bottom of inlet manifold 20b.

Sealing head 142 provides a shoulder 154 that retains spring 139 between inlet manifold 20b and sealing head 142 so that spring 139 acts to bias insert 138 away from inlet manifold 20b and toward tube 150, described below. Spring 139 provides the force necessary to establish a seal between truncated cone 146 and a corresponding frusto-conical section 151 of tube 150. A similar, but inverted insert 156 with a spring 158 and a truncated cone 157 is integrated with effluent manifold 22b to seal between effluent manifold 22b and frusto-conical section 152 of tube 150 and allow the process fluid to flow from tube 150 into conduit 155 and out of effluent insert 156 through effluent lines 159, as shown in FIG. 8.

When each tube 150 is placed between effluent manifold 22b and inlet manifold 20b it is aligned so that frusto-conical sections 151 and 152 of tube 150 line up with truncated cones 146, 157 of inserts 138, 156. When tubes 150 are aligned, a set of bolts 160 are fed through a set of bolt holes 162 in inlet manifold 20b and bolt holes 164 in effluent manifold 22b to secure the manifolds together. Bolts 160 are tightened so that springs 139, 158 are compressed between inlet manifold 20b and insert 138 and between effluent manifold 22b and insert 156. Springs 139, 158 ensure a tight surface-to-surface seal between inserts 138, 156 and tube 150. In one embodiment, inserts 138, 156 and tubes 150 are metal so that surface-to-surface seal 136 is a metal-to-metal seal. An advantage of a metal-to-metal is that it can withstand much higher temperatures than traditional elastomer o-ring seals such as VITON™ or TEFLON™.

Multi-chamber treatment assembly 10 allows for a variety of treatment conditions of one or more materials 2. Treatment assembly 10 can provide for one or more treatment conditions and can simultaneously provide for the treatment of one or more materials 2.

A treatment condition is defined as a distinct treatment fluid composition, treatment fluid flow rate, temperature profile and any other parameter which can be altered to affect the treatment of material 2. For example, if a material 2 is treated with a first treatment fluid having a first flow rate and the material 2 undergoes a first temperature profile, this is considered a first treatment condition. A second treatment conditions is if the same material 2 were treated by a second treatment fluid with the first flow rate and the material 2 and undergoes the same first temperature profile. A third treatment condition is implemented if the same material 2 is treated by the first treatment fluid with a second flow rate under the first temperature profile. Similarly, a forth treatment condition occurs if the material 2 is treated with the first treatment fluid having the first fluid flow rate but undergoes a second temperature profile.

Multi-chamber treatment assembly 10 is designed so that several variables can be selected or controlled, allowing treatment assembly 10 to simultaneously perform a plurality of treatments on a plurality of materials 2. Variables that can be selected or controlled include: materials 2 to be treated in each chamber 12; the treatment fluids that will flow through the materials 2 in each chamber 12, including which fluids, such as H₂ and other gases, H₂O and other liquids, or mixtures of gases and liquids, and the compositions of the fluids; treatment fluid flow rates; and, temperatures of the material 2 in each chamber 12 during treatment, wherein the temperature can be a constant predetermined temperature or a predetermined temperature profile controlled by heating element 62.

In order to control the variables described above, a treatment system (not shown) can be included to flow the treatment fluid to multi-chamber treatment assembly 10 and to control the compositions of the treatment fluid to each chamber 12 of treatment assembly 10. In one embodiment, the treatment system includes a process fluid manifold, a diluent fluid manifold and a liquid feed reservoir. The process fluid manifold feeds a process fluid to a plurality of feed lines, which in turn feed to the plurality of chambers 12. The diluent fluid manifold allows a non-reactive diluent fluid to be fed to each dilute the treatment fluid in the feed lines. One or more liquid pumps, along with the liquid feed reservoir, allow a process liquid to be mixed into the process lines and evaporated before feeding to the plurality of chambers 12. The treatment system can also include a recovery section for knocking out condensables and scrubbing components from the effluent gas before venting to the atmosphere.

An example of a preferred treatment system is described in the commonly assigned patent application having the Attorney Docket # 105397, entitled “Material Heat Treatment System And Method,” filed contemporaneously herewith, the disclosure of which is incorporated herein by reference.

Because each heating element 62 is associated with a specific chamber 12, treatment assembly 10 allows for individual control of the temperature profile within each chamber 12. Treatment assembly 10 can be designed to accommodate several permutations of treatment fluid compositions and flow rates. For discussion purposes, a fluid flow is defined as a particular treatment fluid composition and flow rate and a temperature zone is defined as one or more chamber 12 that undergo a particular temperature profile.

In one arrangement, inlet manifold 20 can be designed so that each inlet line 26 feeds into a separate chamber 12 so that there is one inlet line for each chamber 12. This arrangement would allow for a different treatment fluid flow through each chamber 12. Heating elements 62 can control the temperatures in each chamber 12 of this arrangement so that the temperature in each chamber 12 is the same, resulting in a common heating zone for all chamber 12 in treatment assembly 10, or heating elements 62 can control the temperature profile in each chamber 12 so that there is a different temperature zone for each chamber 12, or for a bank of chambers 12. The installation of insulation can also improve heater efficiency and isolation of heater for more effective temperature control.

In another embodiment, the treatment fluid can be fed to treatment assembly 10 from a common feed line so that each chamber 12 has the same fluid flow and composition. Heating elements 62 can be controlled so each chamber 12 is in a different temperature zone, or so that there are banks of temperature zones, with each temperature zone corresponding to one or more chambers 12.

In yet another embodiment, shown in FIGS. 1, 2, and 3 and described above, each inlet line 26 flows into an inlet channel 28 and each inlet channel 28 feeds into a plurality of chamber 12 arranged in rows that are generally parallel to inlet channels 28. This embodiment allows a different composition and flow rate of the treatment fluid to be fed to each inlet channel 28 so that each row of chamber 12 associated with a particular inlet channel 28 has the same treatment fluid flow. In a preferred embodiment shown in FIG. 2, there are a total of 6 inlet channels 28 so that there can be a total of 6 treatment fluid flows.

Heating elements 62 can be controlled so that there is a different temperature zone along each column of chambers 12, wherein each column is generally perpendicular to inlet channels 28. In one embodiment, shown in FIG. 8, a total of 8 columns of chamber 12 are present, so that there can be eight different temperature zones. The 6 treatment fluid flows described above are arranged perpendicular to the 8 columns so that each chamber 12 has a different fluid flow and temperature profile than every other chamber 12. This arrangement allows for forty-eight different treatment conditions in the same apparatus.

Returning to FIG. 1, an embodiment of the present invention is shown with several additional components of treatment assembly 10. The additional components include a guide plate 180, a heater stop plate 182 and a circuit board guard plate 184, all of which are aligned with inlet manifold 20 and effluent manifold 22 with bolts 53 extending through treatment assembly 10.

When treatment assembly 10 is being assembled, a plurality of tubes 14 or reactor wells 16 are inserted into effluent recess 40 of effluent manifold 22. However, some of the tubes or reactor wells 16 can become misaligned so that they are not perpendicular to effluent manifold 22. If tubes 14 or reactor wells 16 are allowed to remain skewed, then the inlet ends of tubes 14 or reactor wells 16 will not line up with inlet recesses 32 of feed manifold, and treatment assembly 10 will not be able to be assembled properly. Guide plate 180 guides a tube 14 or reactor well 16 by funneling it into the proper orientation as it is placed in treatment assembly 10.

Guide plate 180 can be included to ensure that each tube 14 or reactor well 16 is properly aligned in relation to inlet manifold 20 and effluent manifold 22 so that the inlet end aligns with inlet recess 32 and the outlet end aligns with effluent recess 40. Guide plate 180 defines funnels 186 through which tubes 14 or reactor wells 16 extend. Each funnel 186 has a larger diameter on one side 188 of guide plate 180 and a relatively smaller diameter on the opposite side 190 of guide plate that is slightly smaller than the outer diameter of each tube 14 or reactor well 16. In one embodiment, the larger diameter on side 188 is about twice as large as the outside diameter of tube 14 or reactor well 16. Guide plate 180 includes the same number and the same orientation of funnels 186 as the number of tubes 14 or reactor wells 16 that can be inserted into inlet manifold 20 and effluent manifold 22.

Continuing with FIG. 1, heater stop plate 182 ensures that heating elements 62 remain in the proper orientation with respect to circuit board so that leads 174 remain inserted in heating element connections 172. Heater stop plate 182 includes a plurality of holes 192 which correspond to tubes 14 or reactor wells 16. Each hole 192 has a diameter that is larger than the outer diameter of tube 14 or reactor well 16, but smaller than the outer diameter of heating element 62, as shown in FIG. 1.

Also shown in FIG. 1 is a circuit board guard plate 184 for protecting circuit board 170. Circuit board 170 is made of a heat resistant material for operating at elevated temperature and includes an array of integrated wires (not shown) that provide power to heating elements 62. These integrated components can be delicate and damage easily and can also be expensive. Not only is replacement of circuit board 170 undesirable because of the economic expense, but damage to circuit board 170 during operation of treatment assembly 10 can ruin the treatment of an entire batch of materials 2, requiring a new batch of materials 2 to be treated from the beginning. Circuit board guard plate 184 is included to provide extra protection against damage to the integrated components during assembly and operation of treatment assembly 10.

Like heater stop plate 182, circuit board guard plate 184 also includes a plurality of holes 194 that correspond to tubes 14 or reactor wells 16. Holes 194 have a diameter that is slightly larger than the diameter of heating element 62 so that heating element 62 and leads 174 can extend though a corresponding hole 194 so that leads. 174 can insert into heating element connections 172.

The method by which a material 2 is heat treated in treatment assembly 10 includes the steps of providing a plurality of chambers 12, loading material 2 to be treated into each of the plurality of chambers 12, providing an inlet manifold 20 having at least one inlet channel 28 and an effluent manifold 22 having at least one effluent channel 46, sealing chamber 12 into fluid communication with the inlet manifold 20 and effluent manifold 22, and flowing fluid from inlet manifold 20, through material 2 in each of the chambers 12, and into effluent manifold 22.

A preferred method includes the steps of sealing chamber 12 into fluid communication with inlet channel 28 and effluent channel 46, flowing the fluid from inlet channel 28, through material 2 in each chamber 12 and into effluent channel 46, heating material 2 in at least one of the chamber 12 using heating elements 62, controlling temperature of the material 2 in at least one of the chambers 12, controlling the flow rate of the fluid through material 2 in each of the chambers 12, combining the effluent from each chamber 12 into a common effluent line 52, loading a first material 2a into a first chamber 12 (see FIG. 1) and loading a second material 2b into a second chamber 12, and flowing a first fluid into a first chamber 12 and flowing a second fluid into a second chamber 12.

In another embodiment, the method of heat treating material 2 includes the steps of weighing an empty basket 70, loading material 2 to be treated into basket 70, weighing the loaded basket 70 to determine the mass of material 2 in each basket 70, sealing each of the plurality of housings 72 into an effluent recess 40 in effluent manifold 22, positioning each basket 70 within one of the plurality of housings 72 using the the positioner, sealing each basket 70 into an inlet recess 32 in inlet manifold 20, heating each of the housings 72 with one of the plurality of heating elements 62, flowing a treatment fluid through the plurality of inlet lines 26, flowing the treatment fluid through the plurality of inlet line connections 24, through the restriction orifices 30 of the inlet manifold 20, through the inlet recesses 32, into the plurality of reactor wells 16, out of the plurality of reactor wells 16 through the plurality of effluent recesses 40, through effluent manifold 22, into the plurality of treatment fluid outlet channels and out of treatment assembly 10 through the plurality of process outlet line connections 48 and into outlet lines 50 which are combined into a common effluent line 52.

Before heat treatment of material 2, an empty basket 70 is weighed to determine its mass before material 2 is loaded. A predetermined amount of material 2 is then loaded into basket 70, and basket 70, including loaded material 2, is weighed again. The difference in mass between the first and second weighing determines the mass of material 2 in basket 70.

After loading a plurality of materials 2 into a plurality of baskets 70 using the same method as described above for each basket 70, each of the plurality of baskets 70 loaded with material 2 is positioned within one of the plurality of housings 72. Any one of the three embodiments of the positioner can be employed, so long as the positioner effectively positions basket 70 in housing 72 so that material 2 is within heating zone 64, as described above. It is also important that each inlet o-ring 36 be properly engaged between each basket 70 and a corresponding housing 72.

After the plurality of baskets 70 has been properly positioned within the plurality of housings 72, each chamber 12 can be positioned within treatment assembly 10 so that material 2 can be heat treated. In one embodiment of the method, outlet end 80 of each housing 72 is placed within a corresponding effluent recess 40 so that o-rings 44 engage between each housing 72 and effluent recess 40.

With the plurality of reactor wells 16 in position, inlet manifold 20 can be positioned so that each basket 70 can be sealed within a corresponding inlet recess 32. Inlet end 74 of each basket 70 is placed within a corresponding inlet recess 32 so that o-ring 36 engages between each basket 70 and inlet recesses 32 When each basket 70 is positioned and sealed within a corresponding housing 72 to form a chamber 12, and when each chamber 12 is sealed within a corresponding inlet recess 32 in inlet manifold 20 and a corresponding outlet recess in effluent manifold 22, treatment assembly 10 has been assembled.

When treatment assembly 10 has been completely assembled, the actual heat treatment process can begin. The treatment process can include the steps of heating housing 72 with heating element 62, flowing a treatment fluid through each chamber 12 so that the treatment fluid contacts the plurality of materials 2, stopping the flow of treatment fluid, and turning off heating element 62 to allow each material 2 and each chamber 12 to cool.

Each heating element 62 of treatment assembly 10 is controlled so that a predetermined temperature profile will be present in each heating zone 64, as described above. It is important that each material 2 undergo this temperature profile so that the desired heat treatment of material 2 is achieved. Each heating element 62 should be tightly controlled so that the temperature of each material 2 remains substantially constant, and at the predetermined temperature throughout heat treatment.

As part of the treatment it may be desirable to contact a treatment fluid with each of the plurality of materials 2. In order to contact a treatment fluid, it must first be flowed into each of the plurality of chamber 12 via treatment assembly 10. Treatment fluid is fed to treatment assembly 10 via inlet lines 26 through inlet line connections 24 in inlet manifold 20. The treatment fluid then flows through each of the plurality of inlet channels 28 before flowing through restriction orifices 30 and into the plurality of chambers 12. The pressure within each process inlet line 26 should be sufficiently high to cause the treatment fluid to flow through the entire length of each inlet channel.

After flowing through inlet lines 26 and inlet channels 28, the treatment fluid flows into the plurality of chambers 12. As described above, the flow rate of the treatment fluid through each of the chamber 12 should be controlled and known so that material 2 in each chamber 12 will undergo the desired treatment. After flowing through each chamber 12, the treatment fluid flows through effluent recess 40 and into effluent channels 46 in effluent manifold 22, where it flows out of treatment assembly 10 through process outlet lines 50.

After the treatment fluid has been fed to treatment assembly 10 for a predetermined treatment time, the flow of the treatment fluid is stopped and heating elements 62 are turned off or down to allow reactor wells 16 to cool. In one embodiment the treatment time that material 2 is subjected to is between about 60 minutes and about 24 hours.

After reactor wells 16 and materials 2 have sufficiently cooled, treatment assembly 10 is disassembled by removing each chamber 12 from inlet recesses 32 in inlet manifold 20 and from effluent recess 40 in effluent manifold 22. After treatment assembly 10 has been disassembled, each basket 70 is removed from its corresponding chamber 12 and is weighed again. Any difference between this third weighing and the second weighing described above, after loading material 2 but before heat treatment, determines any change in mass of material 2 during heat treatment.

The inventive multi-well reactor assembly and treatment method of the present invention provides an apparatus and process for the simultaneous and parallel treatment of a plurality of catalysts. The multi-well reactor assembly advantageously feeds a plurality of wells, each holding a catalyst, with a gas to allow simultaneous treatment, and speeding up an already lengthy process.

The method and apparatus of the present invention are exemplified in the following examples.

### EXAMPLE 1

A sample of about 5 grams of ZSM-5 catalyst is measured and loaded into each chamber of forty-eight reactor wells and each reactor well is inserted into a selected column and row of the treatment apparatus.

Six different fluids are fed to the treatment apparatus; wet chlorine gas (HCl/H₂O), pure vaporized water (H₂O), H₂ gas, a 50/50 mixture of O₂ and N₂ gas (O₂/N₂), pure N₂ gas, and a mixture of 75% water and 25% air (H₂O/Air). Each fluid is fed to six chambers at six different flow rates; 2.5 cm³/min, 5 cm₃/min, 7.5 cm³/min, 10 cm³/min, 15 cm₃/min and 25 cm³/min where the flow rates are varied by control valves or by restriction orifices designed to provide the desired flow rate through each chamber. Therefore there are a total of forty-eight different flows fed to the treatment apparatus corresponding to each combination of the six fluids and the eight flow rates, wherein each of the forty-eight flows is fed to one of the forty-eight chambers.

The forty-eight flows are fed to the chambers while heating elements heat each of the forty-eight chambers to a temperature of 300° C. The catalyst in each chamber is maintained at this temperature for a total of 2 hours and then each chamber is allowed to cool slowly until the materials have reached room temperature.

Each of the forty-eight material samples are then removed either for further processing, or for screening to determine which of the samples is most effective for a selected application.

The flow and temperature that a particular sample of material encounters is shown in the following table:

| Cartridge # | Material | Fluid | Flow Rate | | Temperature |
|---|---|---|---|---|---|
| 1 | ZSM-5 | HCl/H₂O | 2.5 | cm³/min | 300° C. |
| 2 | ZSM-5 | HCl/H₂O | 2.5 | cm³/min | 300° C. |
| 3 | ZSM-5 | HCl/H₂O | 2.5 | cm³/min | 300° C. |
| 4 | ZSM-5 | HCl/H₂O | 2.5 | cm³/min | 300° C. |
| 5 | ZSM-5 | HCl/H₂O | 2.5 | cm³/min | 300° C. |
| 6 | ZSM-5 | HCl/H₂O | 2.5 | cm³/min | 300° C. |
| 7 | ZSM-5 | HCl/H₂O | 2.5 | cm³/min | 300° C. |
| 8 | ZSM-5 | HCl/H₂O | 2.5 | cm³/min | 300° C. |
| 9 | ZSM-5 | H₂O | 5 | cm³/min | 300° C. |
| 10 | ZSM-5 | H₂O | 5 | cm³/min | 300° C. |
| 11 | ZSM-5 | H₂O | 5 | cm³/min | 300° C. |
| 12 | ZSM-5 | H₂O | 5 | cm³/min | 300° C. |
| 13 | ZSM-5 | H₂O | 5 | cm³/min | 300° C. |
| 14 | ZSM-5 | H₂O | 5 | cm³/min | 300° C. |
| 15 | ZSM-5 | H₂O | 5 | cm³/min | 300° C. |
| 16 | ZSM-5 | H₂O | 5 | cm³/min | 300° C. |
| 17 | ZSM-5 | H₂ | 7.5 | cm³/min | 300° C. |
| 18 | ZSM-5 | H₂ | 7.5 | cm³/min | 300° C. |
| 19 | ZSM-5 | H₂ | 7.5 | cm³/min | 300° C. |
| 20 | ZSM-5 | H₂ | 7.5 | cm³/min | 300° C. |
| 21 | ZSM-5 | H₂ | 7.5 | cm³/min | 300° C. |
| 22 | ZSM-5 | H₂ | 7.5 | cm³/min | 300° C. |
| 23 | ZSM-5 | H₂ | 7.5 | cm³/min | 300° C. |
| 24 | ZSM-5 | H₂ | 7.5 | cm³/min | 300° C. |
| 25 | ZSM-5 | O₂/N₂ | 10 | cm³/min | 300° C. |
| 26 | ZSM-5 | O₂/N₂ | 10 | cm³/min | 300° C. |
| 27 | ZSM-5 | O₂/N₂ | 10 | cm³/min | 300° C. |
| 28 | ZSM-5 | O₂/N₂ | 10 | cm³/min | 300° C. |
| 29 | ZSM-5 | O₂/N₂ | 10 | cm³/min | 300° C. |
| 30 | ZSM-5 | O₂/N₂ | 10 | cm³/min | 300° C. |
| 31 | ZSM-5 | O₂/N₂ | 10 | cm³/min | 300° C. |
| 32 | ZSM-5 | O₂/N₂ | 10 | cm³/min | 300° C. |
| 33 | ZSM-5 | N₂ | 15 | cm³/min | 300° C. |
| 34 | ZSM-5 | N₂ | 15 | cm³/min | 300° C. |
| 35 | ZSM-5 | N₂ | 15 | cm³/min | 300° C. |
| 36 | ZSM-5 | N₂ | 15 | cm³/min | 300° C. |
| 37 | ZSM-5 | N₂ | 15 | cm³/min | 300° C. |
| 38 | ZSM-5 | N₂ | 15 | cm³/min | 300° C. |
| 39 | ZSM-5 | N₂ | 15 | cm³/min | 300° C. |
| 40 | ZSM-5 | N₂ | 15 | cm³/min | 300° C. |
| 41 | ZSM-5 | H₂O/Air | 25 | cm³/min | 300° C. |
| 42 | ZSM-5 | H₂O/Air | 25 | cm³/min | 300° C. |
| 43 | ZSM-5 | H₂O/Air | 25 | cm³/min | 300° C. |
| 44 | ZSM-5 | H₂O/Air | 25 | cm³/min | 300° C. |
| 45 | ZSM-5 | H₂O/Air | 25 | cm³/min | 300° C. |
| 46 | ZSM-5 | H₂O/Air | 25 | cm³/min | 300° C. |
| 47 | ZSM-5 | H₂O/Air | 25 | cm³/min | 300° C. |
| 48 | ZSM-5 | H₂O/Air | 25 | cm³/min | 300° C. |

### EXAMPLE 2

A sample of about 2 grams of ZSM-11 catalyst is loaded into each chamber of forty-eight reactor wells and each reactor well is inserted into a particular column and row of the treatment apparatus.

H₂ gas is fed to the treatment apparatus in six different inlet lines, wherein each inlet line supplies H₂ to one of six treatment zones, with each treatment zone including eight chambers. The chambers associated with a particular treatment zone are all located in the same row so that there are a total of six rows, with each row having eight chambers per row.

The six inlet lines feed the H₂ gas a different flow rates so that each chamber in the first treatment zone see a flow rate of about 2.5 cm³/min, each chamber in the second treatment zone see a flow rate of about 5 cm³/min, each chamber in the third treatment zone see a flow rate of about 10 cm³/min, each chamber in the fourth treatment zone see a flow rate of about 15 cm³/min, each chamber in the fifth treatment zone see a flow rate of about 20 cm³/min, and each chamber in the sixth treatment zone see a flow rate of about 25 cm³/min.

Each chamber has an associated heating element to heat the material in the chamber to a predetermined temperature, and the heating elements in each column of chambers are set so that each column of chambers is heated to a different temperature. There are a total of eight columns, wherein the columns are perpendicular to the rows described above, and wherein each column includes six chambers. The chambers in the first column are left unheated so that they are at room temperature, about 20° C., the chambers in the second column are heated to a temperature of about 100° C., the chambers in the third column are heated to a temperature of about 150° C., the chambers in the fourth column are heated to a temperature of about 200° C., the chambers of the fifth column are heated to about 250° C., the chambers of the sixth column are heated to about 300° C., the chambers of the seventh column are heated to about 350° C., and the chambers of the eighth column are heated to about 400° C.

The flow of H₂ gas is kept constant for about 1.5 hours and the temperatures of the chambers are maintained at the above temperatures by the heating elements for the full 1.5 hours. After 1.5 hours the flow of H₂ is stopped, the heating elements are turned off and the reactor wells and materials are allowed to cool until they are at room temperature. Each of the forty-eight materials samples are then removed either for further processing, or for screening to determine which of the samples is most effective for a selected application.

The flow and temperature that a particular sample of material encounters is shown in the following table:

| Cartridge | | | | | | | Temper- |
|---|---|---|---|---|---|---|---|
| # | Row | Column | Material | Fluid | Flow Rate | | ature |
| 1 | 1 | 1 | ZSM-11 | H₂ | 2.5 | cm³/min | 20° C. |
| 2 | 1 | 2 | ZSM-11 | H₂ | 2.5 | cm³/min | 100° C. |
| 3 | 1 | 3 | ZSM-11 | H₂ | 2.5 | cm³/min | 150° C. |
| 4 | 1 | 4 | ZSM-11 | H₂ | 2.5 | cm³/min | 200° C. |
| 5 | 1 | 5 | ZSM-11 | H₂ | 2.5 | cm³/min | 250° C. |
| 6 | 1 | 6 | ZSM-11 | H₂ | 2.5 | cm³/min | 300° C. |
| 7 | 1 | 7 | ZSM-11 | H₂ | 2.5 | cm³/min | 350° C. |
| 8 | 1 | 8 | ZSM-11 | H₂ | 2.5 | cm³/min | 400° C. |
| 9 | 2 | 1 | ZSM-11 | H₂ | 5 | cm³/min | 20° C. |
| 10 | 2 | 2 | ZSM-11 | H₂ | 5 | cm³/min | 100° C. |
| 11 | 2 | 3 | ZSM-11 | H₂ | 5 | cm³/min | 150° C. |
| 12 | 2 | 4 | ZSM-11 | H₂ | 5 | cm³/min | 200° C. |
| 13 | 2 | 5 | ZSM-11 | H₂ | 5 | cm³/min | 250° C. |
| 14 | 2 | 6 | ZSM-11 | H₂ | 5 | cm³/min | 300° C. |
| 15 | 2 | 7 | ZSM-11 | H₂ | 5 | cm³/min | 350° C. |
| 16 | 2 | 8 | ZSM-11 | H₂ | 5 | cm³/min | 400° C. |
| 17 | 3 | 1 | ZSM-11 | H₂ | 10 | cm³/min | 20° C. |
| 18 | 3 | 2 | ZSM-11 | H₂ | 10 | cm³/min | 100° C. |
| 19 | 3 | 3 | ZSM-11 | H₂ | 10 | cm³/min | 150° C. |
| 20 | 3 | 4 | ZSM-11 | H₂ | 10 | cm³/min | 200° C. |
| 21 | 3 | 5 | ZSM-11 | H₂ | 10 | cm³/min | 250° C. |
| 22 | 3 | 6 | ZSM-11 | H₂ | 10 | cm³/min | 300° C. |
| 23 | 3 | 7 | ZSM-11 | H₂ | 10 | cm³/min | 350° C. |
| 24 | 3 | 8 | ZSM-11 | H₂ | 10 | cm³/min | 400° C. |
| 25 | 4 | 1 | ZSM-11 | H₂ | 15 | cm³/min | 20° C. |
| 26 | 4 | 2 | ZSM-11 | H₂ | 15 | cm³/min | 100° C. |
| 27 | 4 | 3 | ZSM-11 | H₂ | 15 | cm³/min | 150° C. |
| 28 | 4 | 4 | ZSM-11 | H₂ | 15 | cm³/min | 200° C. |
| 29 | 4 | 5 | ZSM-11 | H₂ | 15 | cm³/min | 250° C. |
| 30 | 4 | 6 | ZSM-11 | H₂ | 15 | cm³/min | 300° C. |
| 31 | 4 | 7 | ZSM-11 | H₂ | 15 | cm³/min | 350° C. |
| 32 | 4 | 8 | ZSM-11 | H₂ | 15 | cm³/min | 400° C. |
| 33 | 5 | 1 | ZSM-11 | H₂ | 20 | cm³/min | 20° C. |
| 34 | 5 | 2 | ZSM-11 | H₂ | 20 | cm³/min | 100° C. |
| 35 | 5 | 3 | ZSM-11 | H₂ | 20 | cm³/min | 150° C. |
| 36 | 5 | 4 | ZSM-11 | H₂ | 20 | cm³/min | 200° C. |
| 37 | 5 | 5 | ZSM-11 | H₂ | 20 | cm³/min | 250° C. |
| 38 | 5 | 6 | ZSM-11 | H₂ | 20 | cm³/min | 300° C. |
| 39 | 5 | 7 | ZSM-11 | H₂ | 20 | cm³/min | 350° C. |
| 40 | 5 | 8 | ZSM-11 | H₂ | 20 | cm³/min | 400° C. |
| 41 | 6 | 1 | ZSM-11 | H₂ | 25 | cm³/min | 20° C. |
| 42 | 6 | 2 | ZSM-11 | H₂ | 25 | cm³/min | 100° C. |
| 43 | 6 | 3 | ZSM-11 | H₂ | 25 | cm³/min | 150° C. |
| 44 | 6 | 4 | ZSM-11 | H₂ | 25 | cm³/min | 200° C. |
| 45 | 6 | 5 | ZSM-11 | H₂ | 25 | cm³/min | 250° C. |
| 46 | 6 | 6 | ZSM-11 | H₂ | 25 | cm³/min | 300° C. |
| 47 | 6 | 7 | ZSM-11 | H₂ | 25 | cm³/min | 350° C. |
| 48 | 6 | 8 | ZSM-11 | H₂ | 25 | cm³/min | 400° C. |

The present invention should not be limited to the above-described embodiments or examples, but should be limited solely by the following claims.

What is claimed is:

1. A material treatment assembly, comprising:
(a) a first manifold having an inlet channel;
(b) a second manifold having an outlet channel;
(c) a plurality of chambers arranged for fluid communication with the first and second manifolds so that fluid can flow from the inlet channel through material in each of the plurality of chambers and thence into the outlet channel;
(d) wherein the material in each of the plurality of chambers maintains a position with respect to at least one of the manifolds; and
(e) at least one seal for each of the plurality of chambers, wherein the at least one seal is adapted to permit repeated placement and removal of material.

2. A material treatment assembly according to claim 1, wherein there are forty-eight chambers arranged for fluid communication with the first and second manifolds.

3. A material treatment assembly according to claim 1, wherein the first manifold has six inlet channels and the second manifold has six outlet channels.

4. A material treatment assembly according to claim 3, wherein each one of the six inlet channels is in fluid communication with eight chambers.

5. A material treatment assembly according to claim 1, wherein the first manifold further comprises a plurality of inlet recesses and wherein each one of the plurality of chambers further comprises an inlet end, wherein each inlet recess is in fluid communication with the inlet channel and wherein each one of the plurality of inlet recesses retains the inlet end of a corresponding one of the plurality of chambers.

6. A material treatment assembly according to claim 5, further comprising a plurality of restriction orifices, one of the restriction orifices being positioned between the inlet channel and a corresponding one of the plurality of inlet recesses, wherein the fluid flow from the inlet channel to each inlet recess flows through at least one of the restriction orifice.

7. A material treatment assembly according to claim 5, wherein the at least one seal is an o-ring that is retained within each one of the plurality of inlet recesses and wherein the o-ring establishes a seal between the first manifold and the corresponding one of the plurality of chambers.

8. A material treatment assembly according to claim 1, wherein the second manifold further comprises a plurality of outlet recesses and each of the plurality of chambers further comprises an outlet end, wherein each outlet recess is in fluid communication with the outlet channel and wherein each one of the plurality of outlet recesses retains the outlet end of a corresponding one of the plurality of chambers.

9. A material treatment assembly according to claim 8, wherein the at least one seal is an o-ring that is retained within each one of the plurality of outlet recesses and wherein the o-ring establishes a seal between the second manifold and the corresponding one of the plurality of chambers.

10. A material treatment assembly according to claim 1, further comprising a plurality of heating elements for heating the material in the chambers, each heating element at least partially surrounding a corresponding one of the plurality of chambers.

11. A material treatment assembly according to claim 10, wherein the heating elements are replaceable.

12. A material treatment assembly according to claim 1, wherein each one of the plurality of chambers further comprises a porous material support for supporting the material in position within the one of the plurality of chambers.

13. A material treatment assembly according to claim 1, wherein the first and second manifolds are glass filled with TEFLON™.

14. A material treatment assembly according to claim 1, wherein each chamber is enclosed within a tube.

15. A material treatment assembly according to claim 1, wherein each chamber is enclosed within an insert, and wherein each insert is enclosed within a housing.

16. A method for treating material in a multi-chamber assembly, comprising the steps of:
(a) providing a plurality of chambers;
(b) loading material to be treated into each of the plurality of chambers;
(c) providing an inlet manifold having an inlet channel and an effluent manifold having an effluent channel;
(d) sealing the chambers into fluid communication with said manifolds; and
(e) flowing fluid from the inlet manifold, through the material in each of the chambers, and into the effluent manifold.

17. A method for treating material according to claim 16, wherein the sealing step includes sealing the chambers into fluid communication with the inlet channel and the effluent channel.

18. A method for treating material according to claim 17, wherein the flowing step includes flowing fluid from the inlet channel, through the material in each of the chambers, and into the effluent channel.

19. A method for treating material according to claim 16, further comprising heating the material in at least one of the plurality of chambers.

20. A method for treating material according to claim 16, further comprising controlling the temperature of the material in at least one of the plurality of chambers.

21. A method for treating material according to claim 16, further comprising controlling flow rate of the fluid through each one of the plurality of chambers.

22. A method for treating material according to claim 16, wherein an effluent flows out of each chamber, further comprising combining the effluent from each chamber into a common effluent line.

23. A method for treating material according to claim 16, wherein the loading step includes loading a first material into a first one of the plurality of chambers and loading a second material into a second one of the plurality of chambers.

24. A method for treating material according to claim 16, wherein the flowing step includes flowing a first fluid into a first one of the plurality of chambers and flowing a second fluid into a second one of the plurality of chambers.
